(19) United States
(12) Patent Application Publication
(10) Pub. No.: US 2011/0225047 A1
(43) Pub. Date: Sep. 15, 2011

(54) APPARATUS AND METHODS FOR GENERATION AND UTILIZATION OF SALES LEADS

(76) Inventors: Paul Breed, Solana Beach, CA (US); James Irish, San Diego, CA (US)

(21) Appl. No.: 13/007,837

(22) Filed: Jan. 17, 2011

Related U.S. Application Data
(60) Provisional application No. 61/303,209, filed on Feb. 10, 2010.

(51) Int. Cl. G06Q 30/00

(52) U.S. Cl. 705/14.55; 705/14.73; 705/14.58; 705/14.69

(57) ABSTRACT

Methods and apparatus for generating and utilizing sales leads and related information. In one embodiment, an item information collection (IIC) server communicates with a plurality of client devices via a web server and/or an SMS server. The IIC server services requests for information regarding subject vehicles by forwarding information in the request to vehicle information sources. The resulting information is compiled and formatted for provision to the customer. The IIC server provides portions of the information to advertisers and related product/service providers according to one or more business rules. An operator of the IIC server may charge a premium to the advertisers and related product/service providers for the ability to present information and advertisements to the customer. Where the information includes customer contact information, the advertiser may optionally contact the customer directly. Business methods and rules for lead generation and utilization are also disclosed.

### PRIORITY AND RELATED APPLICATIONS

This application is related to and claims priority to co-owned, co-pending U.S. Provisional Patent Application Ser. No. 61/303,209, filed on Feb. 10, 2010 of the same title, which is incorporated herein by reference in its entirety. This application is also related to U.S. Provisional Patent Application Ser. No. 61/134,655, filed on Jul. 10, 2008 and entitled “APPARATUS AND METHODS FOR EFFICIENT DELIVERY OF AUCTION ITEM INFORMATION”, U.S. Provisional Patent Application Ser. No. 61/218,335, filed on Jun. 18, 2009 and entitled “APPARATUS AND METHODS FOR EFFICIENT DELIVERY OF AUCTION ITEM INFORMATION”, and U.S. patent application Ser. No. 12/500, 513, filed on Jul. 9, 2009 and also entitled “APPARATUS AND METHODS FOR EFFICIENT DELIVERY OF AUCTION ITEM INFORMATION”, each of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates in one exemplary aspect to improved methods and apparatus for utilizing information obtained from users (e.g., consumers) to generate and utilize sales or marketing leads.

2. Description of Related Technology

Advances in communication technology have lead to an ability of cellular and digital telephone users to communicate without the typical restraints of conventional landline telephone use. Specifically, present wireless devices have the capacity to send and receive short-text messages through a short messaging service (SMS).

SMS traffic, in the U.S. in particular, has seen widespread popularity. In reaction to the wide adoption of SMS, advertisers have begun adapting the platform for marketing purposes. The one-to-one nature of advertising on a personal wireless device, as well as the instant nature of SMS messages, makes for an attractive marketing method. However, due in large part to the opt-in nature of SMS marketing, the process of promoting a mobile campaign to generate exposure still requires considerable resources. Often, advertisements are distributed widely with a mere hope that a potential customer will receive the advertisement, and are not often used with qualified advertising leads.

Advertising or sales leads are terms used to refer to potential customers who may be particularly interested in a product or service. Historically, advertising leads are generated by direct marketing (including Internet marketing) and/or cold calling. Generally, advertising leads do not have much value unless the lead is qualified or otherwise characterized as a sales prospect. For example, advertising leads may be qualified by identifying (such as by direct interrogation) the lead's product applicability, availability of funding, and time frame for purchase.

Additionally, with the widespread availability of information, consumers are becoming increasingly savvy with respect to major purchases. For example, consumers in the market for a vehicle are more apt to “shop around” for competitive pricing, and also check the history of a particular vehicle and its estimated value prior to purchase. Extant services for providing vehicle history information include e.g., Autocheck™, CARFAX®, etc. Services for providing value estimates for vehicles include e.g., Kelly Blue Book (KBB)™, Edmunds™, etc. Services for finding potential vehicles of interest include e.g., AutoTrader, Car.com, and the like. However, gathering information about a particular vehicle (or obtaining additional candidate vehicles) has required research at various service providers (such as the aforementioned KBB, CARFAX, department of transportation, AutoTrader, etc.) via more than one communication means (physical presence, the Internet, telephone call, etc.). This can be unduly time consuming, and costly, and highly latent.

Notably, the point of contact and the point of the lead are not at the point of sale (e.g., the showroom or dealer where the customer is evaluating the vehicle, or the private location where a customer is evaluating a private party-owned vehicle in a private sale) under this prior art model, thereby creating inter alia an undesirable latency and possible geographic disparity.

The prior art also disadvantageously has difficulty verifying the identity and authenticity of a lead (e.g., prospective purchaser), in that there is no requirement that verifiable data be entered. For instance, an on-line customer might simply enter a fictitious name, or a bogus telephone contact number, and the ultimate user of the lead has no way of filtering such bogus leads out from authentic ones. Specifically, the more timely the relevant information for the sale or purchase opportunity is provided, generally the more utility it will have for the user of that information (as well as for those attempting to market or advertise similar or complementary goods to that user). This phenomenon is somewhat akin to so-called “point of purchase” displays, whereby a customer's impulsiveness is leveraged in order to facilitate them making a purchase that they might not make otherwise. Hence, latent information sources or services cannot take maximum advantage of this behavior, since the user generally cannot access them all in a timely manner at the point of sale (e.g., a vehicle dealership or private party location) and filter/integrate the data in order to come to a useful conclusion.

For example, under current prior art, the user might be able to access a vehicle history report based on a VIN number for a vehicle of interest while in the showroom or private party location (e.g., via a 3G or 4G “smartphone” with Internet connectivity), but then for ancillary or complementary products or services (e.g., insurance, financing, extended warranty, accessories), and/or other vehicle candidates, they must serially access each of these sources (again, via their smartphone, or laptop/home computer). As an example, suppose a user wishes to investigate a used Aston Martin DBS vehicle he/she has seen while at a dealership. Under the prior art, the user would (i) access the Internet via their smartphone web browser, (ii) access the appropriate website (if known) for researching the car history; (iii) enter the vehicle VIN; and (iv) obtain and review the result. If the result was satisfactory, the user might then (v) access a financing company website; (vi) fill out an on-line application or query for a quote; and (vii) await a call or email from that company, which could take minutes or days. If the result of the vehicle history report of (i)-(iv) was unsatisfactory, the user might then consult a third party website (such as AutoTrader) to search for other Aston Martin DBS vehicles in the area. The user would then need to browse through any viable entries, locate the dealer(s), etc. The same process would be employed again for obtaining an insurance quote, warranty cost estimate, etc. The foregoing process (i) is clearly not optimized for both ease of use and time, and (ii) requires a significant degree of forehand knowledge by the user (e.g., for the financing company website, AutoTrader site, etc., etc.), or alternatively significant investment in time and effort to find such sites.

Yet another problem with the prior art relates to the number of leads. As indicated above, the authenticity or veracity of a given lead is at best questionable under the prior art, and when coupled with the many leads typically generated under the prior art methods, the consumer of the lead has great difficulty separating the “chaff from the wheat” as it were. For instance, ten leads of questionable pedigree might be mixed in with one viable, authentic lead, and the lead consumer has no way of knowing which are which.

Hence what are needed are efficient, time-sensitive, substantially integrated, and cost-effective methods and apparatus for providing information to a consumer regarding a possible purchase or sale of an item or service. Such improved techniques and apparatus would optionally provide to a user a plurality of information from various sources upon a single user request.

Moreover, it is beneficial to the information supplier to tie the supplying of item information to a customer, thereby generating a qualified sales lead. In other words, supplying information to the customer may be associated with an estimate of the interest level of the customer in the subject item or service, as well as other related products and/or services; hence, information about the customer (and the subject item/service) may be sold to advertisers for a profit.

Ideally, the foregoing improved techniques and apparatus would also be compatible with existing and incipient personal electronics and networking technologies so as to provide information and advertising in a substantially ubiquitous and/or recognizable format, including for example a format similar to the format of the customer's request for information if desired.

### SUMMARY OF THE INVENTION

The present invention satisfies the foregoing needs by providing, inter alia, apparatus and methods for utilizing information obtained from consumers to generate and utilize sales leads.

In a first aspect of the invention, a method for generating and utilizing sales leads is disclosed. In one embodiment, the method comprises: receiving a request for first information regarding an item for sale from a user device; transmitting second information associated with said request to one or more advertising entities, said transmitting enabling said user device to receive at least one advertisement or solicitation related to said item; obtaining said requested first information; and formatting said requested information into a format suitable for use by said user device.

In one variant, the formatting comprises formatting into an SMS or text message format.

In a second embodiment, the method comprises: receiving a request for information regarding an item for sale from a client device; transmitting at least a portion of information contained in the request to one or more item information sources; transmitting at least a portion of the information contained in the request to one or more advertising entities; receiving the requested information; receiving at least one advertisement related to the information contained in the request; and formatting the requested information and the at least one advertisement into a format suitable for transmission to the client device.

In a second aspect of the invention, a server apparatus is disclosed. In one embodiment, the server comprises a web or network server adapted to receive information requests from one or more user devices, and provide the requested information back to the requesting user(s), along with providing user-specific data to one or more third parties (e.g., advertisers).

In a third aspect of the invention, a client device adapted for issuing requests relating to goods or services is disclosed. In one variant, the device comprises a mobile device (e.g., smartphone or PDA) enabled with SMS or text messaging capability and a client application which generates and forwards particular types of information to a distant entity (e.g., the aforementioned server).

In a fourth aspect of the invention, a system adapted for providing timely vehicle information and advertising leads is disclosed.

In a fifth aspect of the invention, methods of doing business are disclosed.

In a sixth aspect of the invention, a supervisory “rules engine” is disclosed. In one embodiment, the rules engine comprises one or more computer programs operative to run on the aforementioned server and implement various business and operational decisions and rules.

Other features and advantages of the present invention will immediately be recognized by persons of ordinary skill in the art with reference to the attached drawings and detailed description of exemplary embodiments as given below.

### BRIEF DESCRIPTION OF THE DRAWINGS

FIG. 1 is a block diagram illustrating an exemplary network architecture useful for the generation and utilization of sales leads according to the present invention.

FIG. 1a is a block diagram illustrating an exemplary item information collection (IIC) server of FIG. 1.

FIG. 2 is a logical flow diagram illustrating an exemplary method for lead generation and utilization according to the present invention. FIG. 2a is a logical flow diagram illustrating another exemplary method for lead generation and utilization according to the present invention.

FIG. 3 is a logical flow diagram illustrating an exemplary method for providing sales leads to advertisers according to the present invention.

FIG. 4 is logical flow diagram illustrating an exemplary method for providing sales leads to additional service providers according to the present invention.

FIG. 4a is a logical flow diagram illustrating an exemplary method of lead utilization by a warranty provider.

FIG. 4b is a logical flow diagram illustrating an exemplary method of lead utilization by an insurance provider.

FIG. 4c is a logical flow diagram illustrating an exemplary method of lead utilization by a financing provider.

FIG. 5 is a block diagram illustrating an exemplary vehicle identification number (VIN) according to the present invention.

FIG. 6 is a logical flow diagram illustrating an exemplary method of utilizing a shortened VIN to obtain information from the IIC server of FIG. 1.

### DESCRIPTION OF THE INVENTION

Reference is now made to the drawings listed above, wherein like numerals refer to like parts throughout.

As used herein, the term “application” refers generally to a unit of executable software that implements theme-based functionality The themes of applications vary broadly across any number of disciplines and functions (such as e-commerce transactions, shipping transactions, entertainment, calculator, Internet access, etc.), and one application may have more than one theme. The unit of executable software generally runs in a predetermined environment; for example and without limitation, the unit could comprise a downloadable Java XIet™ that runs within the JavaTV™ environment

As used herein, the terms “client device,” and “user device” include, but are not limited to, personal computers (PCs), whether desktop, laptop, or otherwise, personal digital assistants (PDAs) such as the “Palm®” family of devices, cellular or “smart” phones such as the Apple iPhone, handheld computers, J2ME equipped devices, personal media devices, set-top boxes, or literally any other device capable of interchanging data with a network. Such devices may interface using wired or optical fiber mechanisms such as an IEEE Std. 802.3 Ethernet interface, Digital Subscriber Line (DSL), DOCSIS modem, hybrid fiber-coax (HFC) cable, FireWire (IEEE Std. 1394), or alternatively via wireless mechanisms and protocols such as 3GPP/3GPP2, Bluetooth™, IrDA interface, IEEE Std. 802.11, UWB (e.g., IEEE-Std. 802.15 or similar), WiMAX (802.16), Wireless Application Protocol (WAP), GPRS, GSM, or any other of myriad data communication systems and protocols well known to those of skill in the communications arts.

As used herein, the term “computer program” is meant to include any sequence of human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “database” refers generally to one or more tangible or virtual data storage locations, which may or may not be physically co-located with each other or other system components.

As used herein, the term “digital processor” is meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “display” means any type of device adapted to display information, including without limitation CRTs, LCDs, TFTs, plasma displays, LEDs, and fluorescent devices.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the term “network” refers generally to data or communications networks regardless of type, including without limitation, LANs, WANs, intranets, internets, the Internet, cable systems, telecommunications networks, satellite networks, and Virtual Private Networks (VPNs), or collections or combinations thereof, whether based on wired, wireless, or matter wave modalities. Such networks may utilize literally any physical architectures and topologies (e.g. ATM, IEEE-802.3, X.25, Token Ring, SONET, 3G/3GPP/UMTS, 802.11, 802.16, 802.15, Hybrid fiber-coax (HFC), etc.) and protocols (e.g., TCP/IP, HTTP, FTP, WAP, GPRS, RTP/RTCP, etc.).

As used herein, the term “speech recognition” refers to any methodology or technique by which human or other speech can be interpreted and converted to an electronic or data format or signals related thereto. It will be recognized that any number of different forms of spectral analysis (such as MFCC (Mel Frequency Cepstral Coefficients) or cochlea modeling, may be used. Phoneme/word recognition, if used, may be based on HMM (hidden Markov modeling), although other processes such as, without limitation, DTW (Dynamic Time Warping) or NNs (Neural Networks) may be used. Myriad speech recognition systems and algorithms are available, all considered within the scope of the invention disclosed herein.

As used herein, the term “vehicle” refers to any form of air, land or water transportation for either person, animals, and/or inanimate objects including, without limitation, buses, cars, sports utility vehicles, all terrain vehicles, motorcycles, boats etc.

### OVERVIEW

The present invention provides, inter alia, methods and apparatus for generating and utilizing sales leads. In one exemplary embodiment, an item information collection (IIC) server is used in communication with a plurality of client devices via at least a web server and/or a short messaging service (SMS) server. The IIC server receives requests from the client devices for information regarding subject vehicles. The IIC server forwards information contained in the requests to various vehicle information sources. The IIC server compiles and formats information relating to requested vehicles received from the information sources. In addition, the IIC server provides portions of the information to certain ones of advertisers and related product/service providers. These related product/service providers generate or access product or service information which may be of interest to the customer, and provide this information to the IIC server (or otherwise direct the server where to find the information). The server then optionally employs one or more business rules for determining which of the information is presented to the user. An operator of the IIC server may for example charge a premium to the related product/service providers for this service, and/or the ability to present their information to the customer (or present it in a specified relationship to the information provided by other competing product/service providers). The information provided to the advertisers may be sold to these entities at a premium as “qualified” sales leads. Where the information includes contact information for the customer, the advertiser may contact the customer directly (assuming the customer has assented or opted-in for such direct contact). In one embodiment, the advertiser may be a dealer offering the subject vehicle for sale. Alternatively, competing dealers may be given an opportunity to present their comparable vehicles to the customer. Business methods and rules for guiding the lead generation and utilization methods are also discussed herein.

The present invention advantageously solves the previously identified problems by, among other things, (i) presenting a limited number (e.g., one) of qualified, authentic sales leads for each consumer, versus a plurality of unqualified leads of unknown authenticity, and (ii) eliminating temporal and geographic disparity (i.e., removing latency, and making the information highly geographically relevant to the user's present geographic context). Stated simply, various embodiments of the invention provide highly useful and relevant information where and when it is most useful and needed, all within an easy-to-access communications paradigm.

### DESCRIPTION OF EXEMPLARY EMBODIMENTS

It is noted that while the system and methods of the invention disclosed herein are described with respect to delivery of information regarding vehicles, certain aspects of the invention may be useful in other applications, including, without limitation, various types chattel and/or services.

### Network Architecture—

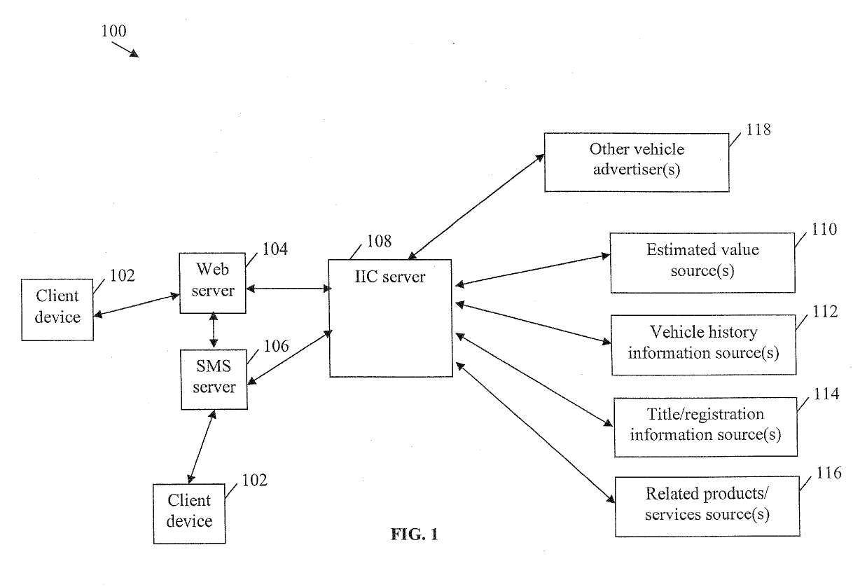

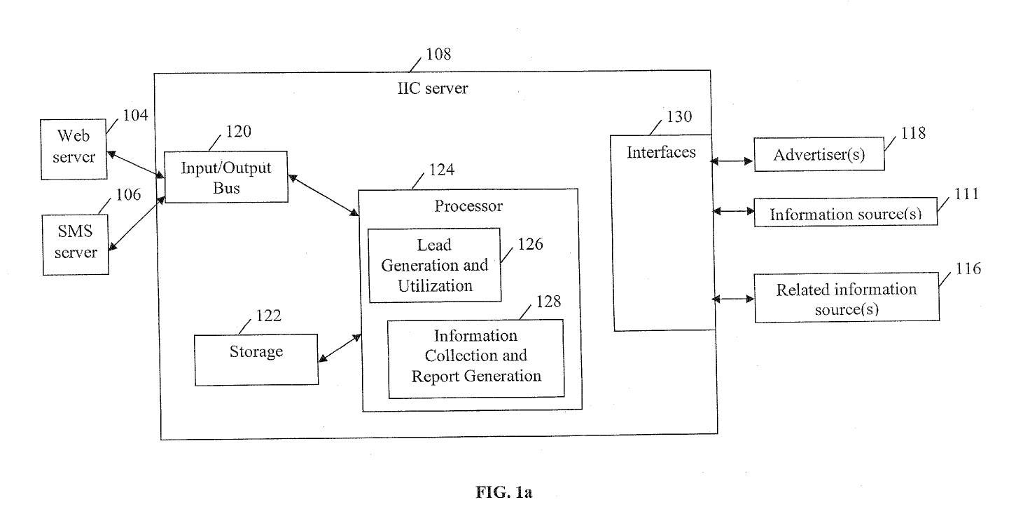

FIG. 1 illustrates an exemplary network architecture useful for the generation and utilization of sales leads. As shown, the system 100 generally comprises a plurality of client devices 102 in communication with an item information collection (IIC) server 108 either via a web server 104 or a short message service (SMS) server 106 (and interposed networks, such as that of a cellular service provider, and/or the Internet). The IIC server 108 compiles and provides information regarding items for sale to the client devices 102.

At a client device 102, the client enters vehicle identification information (such as e.g., the vehicle VIN number) as a text message or internet-based message (such as email or instant message). In yet another embodiment, the client may enter other identifying information about the vehicle such as e.g., the vehicle make, model and/or year. The identifying information is then sent to an SMS server 106 or web server 104 which forwards the message to the IIC server 108.

In another embodiment, the client may, rather than inputting the vehicle VIN number, instead use a camera function of the client device 102 to take a picture of the VIN number, or OCR software and a scanner. The client device 102 will then utilize the optical character recognition program (such as GOCR, JOCR, etc.) to convert the pictured image to text, the text is then sent to the SMS server 106 and on to the IIC server 108 as discussed above. Or, in another variant, the image is sent to the server, which then conducts its own decoding/reading (e.g., via OCR, human intervention, etc.).

It is appreciated that other forms of data (e.g., VIN) entry may also be utilized including e.g., speaking or saying the number into a client device capable of recognizing and translating the speech to text. For instance, a speech recognition algorithm may be resident within the program memory of the device 102, and in conjunction with a microphone, convert received analog signals from a user to a digital data representation. Such speech recognition algorithms and systems are well known in the art, and accordingly not described further herein.

In yet another embodiment, the speech recognition system may be implemented at the IIC server 108 or other entity of the invention described herein.

At the IIC server 108, the vehicle identifier may be cross-referenced to the VIN number (if necessary); the VIN number may then be used in a request message which is sent to the estimated value source 110, vehicle history information source 112, and/or title/registration information source 114 (referred to herein collectively as “information sources”).

In the exemplary embodiment of FIG. 1, the IIC server 108 requests information from one or more estimated value sources 110, vehicle history information sources 112, and title/registration information sources 114; however alternate information sources adapted to transmit information regarding used items may also be used consistent with the present invention.

The estimated value sources 110 may include e.g., an estimated resale server and/or a wholesale server; upon IIC server 108 request, the estimated value sources 110 provides estimated value reports (EVR) to the IIC server 108. The EVR includes an estimate of the amount for which the vehicle may be resold and/or the estimated wholesale value of the vehicle.

The vehicle history information sources 112 use the vehicle VIN to retrieve a vehicle history report (VHR). In one embodiment, the vehicle history information sources 112 are configured to return history reports generated by, inter alia, Autocheck, CARFAX,, and/or generated by any number of web-based servers such as, inter alia, isitalemon.com, ebay.com, and cardectective.com. In one embodiment, a full vehicle report is truncated or reformatted prior to provision to the client device 102 (discussed below).

The title/registration information sources 114 use the vehicle VIN to retrieve title and registration information regarding the vehicle. For example, the title/registration information sources may include e.g., a department of motor vehicles (DMV) database, and/or web-based servers including e.g., eztitlesearch.com, Gov-Reports.com, etc.

The IIC server 100 is adapted to receive and compile any reports received from the various item information sources 110, 112, 114 (including, inter alia, EVR, VHR, etc.). Computer applications running on the IIC server 108 (discussed below) direct the formatting of the reported information into a form that is suitable for transmission. For example, the information may be reported back to the client device 102 via SMS text message, email message, voice message, etc. In one embodiment, the collected data is formatted by summarizing and/or presenting only portions of the data received so as to generate a message which is most germane or suitable (i.e., simple or small enough) for transmission to a client via text or other messaging in a timely and reliable manner.

The IIC 108 of the present invention is further configured to communicate with advertiser(s) 118 as well as other entities. As will be discussed in greater detail below, the IIC server 108 may provide certain information to the advertiser(s) 118 regarding a customer associated with a request received at the IIC 108 from a client device 102. The IIC 108 may provide information regarding an item which the customer requested information about to the advertiser as well, or in another variant, logically or contextually related goods or services. In the illustrated embodiment, the one or more advertisers 118 comprise advertisers or sources for other vehicles (perhaps of the same type being investigated by the user); however, it is appreciated that the advertiser 118 may comprise the same dealer who is selling the vehicle which the customer has inquired into (e.g., for the same model at another lot of the same dealer, or for a different model in which the dealer feels the user may have an interest).

Also illustrated, the HC 108 is in communication with one or more related products/services sources 116. As will be discussed in greater detail below, the IIC server 108 may provide portions of the information obtained from the customer request and/or portions of the information obtained from the other information sources 110, 112, 114 to the related products/services sources 116. The related products/services sources 116 use the information to generate highly targeted advertisements for products and/or services which are related to the customer's interest in the subject vehicle. For example, the related products/services sources 116 may comprise vehicle warranty providers, insurance providers, financing providers, accessory or aftermarket parts providers, etc.

The IIC server 108 may be in communication with any number or type of additional information sources, advertisers and/or related products/services providers, the foregoing being merely illustrative. Additionally, it is appreciated that one or more of the foregoing servers (IIC server 108, web server 104, and SMS server 106) may be utilized consistent with the present invention to provide these communication functions. Moreover, two or more of the foregoing servers may be combined at logical and/or physical level, the actual configuration being merely a design choice.

It will also be appreciated that various embodiments of the present invention may be configured to provide augmentation or enhancement/enrichment of data. For instance, in one such variant, the IIC server or other entity may “ping” or query other sources, servers, etc. for information which may make the lead more valuable to an end consumer (e.g., service provider or advertiser). For instance, while the foregoing embodiments of the invention inherently produce a level of authentication or veracity to the identity of a lead (as well as ostensibly their bona fide intent to purchase by virtue of their presence at the dealership), the utility of such a lead can be further enhanced by the addition of a FICO or credit score, or other descriptive information which may help the advertiser or end user of the lead evaluate and decide to pursue the lead. Such enrichment or augmentation services can also be the basis of an ancillary business model or industry; i.e., enhancement of real-time sales leads in a seamless fashion, for consideration (e.g., the enhancer may charge the ultimate lead user an additional fee for the enhancement, or build this fee into the cost of the lead, etc.).

The formatted message containing information gained from the information sources 110, 112, 114 and the related products/services sources 116 is then sent to the client device 102 via e.g., the SMS server 106 according to standard SMS message protocol. The message may also or alternatively be sent via the web server 104 via the Internet protocol (IP). This approach (use of extant SMS servers 106 and/or web servers 104 as well as extant protocols) advantageously obviates the need for additional adaptation or modification of the existing cellular or wireless infrastructure, although it will be appreciated that other bearer transports and protocols may be used consistent with the invention.

Although not illustrated in FIG. 1, the other advertisers 118 may be provided with information enabling one or more of these entities to contact the customer directly at the client device 102 (discussed below).

As illustrated in FIG. 1a, the IIC server 108 generally comprises a storage device 122, a digital processor 124 and a plurality of interfaces 130.

The interfaces 130 of the IIC server 108 is the subsystem for the transfer of data into and out of the IIC server 108. For example, data, such as a request for item information, may be transferred into the server 108 from client devices 102 via the SMS server 106 (and/or the web server 104); item information and advertisements may then be transferred out of the server 108 to the SMS server 106 (and/or web server 104) and on to the requesting client devices 102. These interfaces may comprise any number and type of interface, including wireless (e.g., WLAN, WiMAX, cellular, CDPD, FLO, PAN, IRdA, etc.), wired (e.g., LAN, GBE, DOCSIS, DSL, PSTN, T1, ISDN, etc.), or optical (e.g., FIOS, PON, etc.).

The storage device 106 of the IIC server 100 is adapted to store inter alia processed and formatted item information (including additional information as discussed below). In one embodiment, the items may comprise vehicles and the processed and formatted item information may be arranged in storage by vehicle identification number (VIN). In another embodiment, items are referenced by shortened VIN number (such as the last 6-8 digits; discussed below), or other identifier which is then cross-referenced to a VIN. The storage device may comprise for example separate program and data memories, a HDD, optical storage, or other mass storage device(s).

As illustrated, the IIC server 108 further comprises a digital processor 124 configured to run one or more applications stored thereon. The digital processor (e.g., RISC, CISC, DSP, etc.) 124 may run a first computer program 128 configured to facilitate information collection and report generation. The information collection and report generation program 128 causes the server to generate requests to various item information sources 110, 112, 114, other vehicle advertisers 118, and related products/services sources 116, as well as format data received from these sources 110, 112, 114, 116, 118 into data reports which are more efficiently transmitted and more easily read by the client devices 102 associated with the SMS server 106 and/or the web server 104.

The digital processor 124 of the illustrated embodiment runs a second computer program 126 configured to facilitate lead generation and utilization functions. The lead generation and utilization program 126 is responsible for triggering the ITC server 108 to collect identifying information (contact information, demographic information, and/or other data) about a requesting device 102 and/or information regarding the item which was inquired into. For example, the IIC server 108 may, upon receipt of a request for information regarding a particular vehicle from a specific device 102, generate a request record for that device 102. The request record (not shown) contains contact information (such as a phone number, email address, etc.), demographic information (such as age, income bracket, credit score or credit worthiness score, etc.), psychographic information, and/or geographic information (such as zip code, area code, etc.). Historical or behavioral data may also be collected (e.g., how frequently the user uses the VIN service of the present invention). The request record may also contain information regarding the item; this information may identify the item (such as VIN) and/or other information which is compiled in response to the information request. For example, certain information gained from the information sources 110, 112, 114 may be collected and provided to the requesting device 102 as well as added to the request record. The lead generation and utilization program 126 is further responsible for determining which advertisers 118 and related products/services providers 116 are entitled to any or all of the information in the request record.

It will be recognized that the client device 102 may be configured in any number of ways in order to effect the foregoing request message/record functionality. For instance, in one variant, the user simply texts the entire VIN (or selected portions thereof, such as the last 5 or 6 digits) to a given address or site. In another variant of the invention, the client device (e.g., mobile phone, PDA, etc.) is configured with a client application which enables the client to generate a user interface for display on the user's device, as well as customized requests that further facilitate processing of the request (and generation of sales lead information as described elsewhere herein). Specifically, while some embodiments of the invention is based on extant or indigenous capabilities of the client device (i.e., no special software or components required, just text capability and/or an Internet browser or email client), other embodiments of the invention utilize a downloaded or installed client application which provides other functionality such as the inclusion of ancillary information sent to the server servicing the information request. This ancillary information enables the end-user advertisers to better target their advertisements or solicitations to the particular requesting user, such as based on: (i) geographic location; (ii) demographics; (iii) historical or anecdotal use patterns or events; or (iv) prescribed descriptors or preferences put in place by the user/requester.

Moreover, some variants of the client or user interface may allow the user to configure or personalize their interaction with the service, such as specifying user preferences for the type, timing, etc. of the information received either directly or from advertisers/other sources. For instance, a user may “opt in” for having advertisers or other parties contact them as previously described, yet specify that such “backscatter” from their request occur only during certain windows of time (e.g., during normal working hours, within one hour of the request, only when they are within certain geographical coordinates or location ranges, etc.).

It is also noted that as part of the foregoing exemplary “opt in” process, one embodiment of the invention causes the user to enter information which has a high degree of authenticity (i.e., which cannot be easily changed or misstated). For example, a user's contact information is necessarily accurate and representative, since they will e.g., have to supply credit card or other payment information. All of this information must “line up” for the transaction to process, and accordingly the present invention contemplates vetting users by such non-matching information (i.e., filtering those signing up where one or more of the address, name, telephone number, etc. does not reconcile with existing databases).

The various functions of the IIC server 108 (as executed by the aforementioned applications 126, 128) can also be masked or controlled by a “business rules engine” or other logical wrapper or layer as described subsequently herein. Other functions of the digital processor 124 and IIC server 108 will be discussed in detail below as well.

It is also noted that various embodiments of the invention are configured to permit the advertiser (e.g., insurance carrier, finance company, etc.) to view a vehicle history (or portions thereof) in a timely manner. This capability advantageously allows the advertiser to evaluate and determine if they want to utilize the lead, and/or offer their service with respect to a particular vehicle. For instance, if a lead is generated for a well qualified buyer, but the vehicle of interest is a “lemon” or historically unprofitable for that advertiser, they may wish to avoid purchase or use of the lead. This can be implemented on a per-manufacturer basis (e.g., all Toyotas), on a per-model basis (e.g., all Toyota Prius), or on a per-vehicle basis (e.g., VIN No. XYZ123ABC456). As noted elsewhere herein, this evaluation capability also extends to the prospective customer (e.g., John Jones living at 1313 Mockingbird Lane has a history of loan default or multiple bankruptcies), whether alone or in conjunction with the vehicle evaluation/history.

In the illustrated embodiment, the IIC server 130 communicates with other vehicle advertisers 118, information sources 111, and related products/services sources 116 via the interfaces 130. The information sources 111 may include inter alia, estimated value sources 110, vehicle history information sources 112, and title/registration information sources 114, although other information sources may also be utilized.

In one embodiment, the server and other apparatus disclosed in co-owned, co-pending U.S. patent applicant Ser. No. 12/500, 513, filed on Jul. 9, 2009 and entitled “APPARATUS AND METHODS FOR EFFICIENT DELIVERY OF AUCTION ITEM INFORMATION”, which is incorporated herein by reference in its entirety, may be utilized implemented for providing at least some of the aforementioned functionality of the IIC server 108 discussed herein.

It is also appreciated that the methods of the present invention may be practiced using any configuration or combination of hardware, firmware, or software, and may be disposed within one or any number of different physical or logical entities. Myriad different configurations for practicing the invention will be recognized by those of ordinary skill in the network arts provided the present disclosure.

### Methodology—

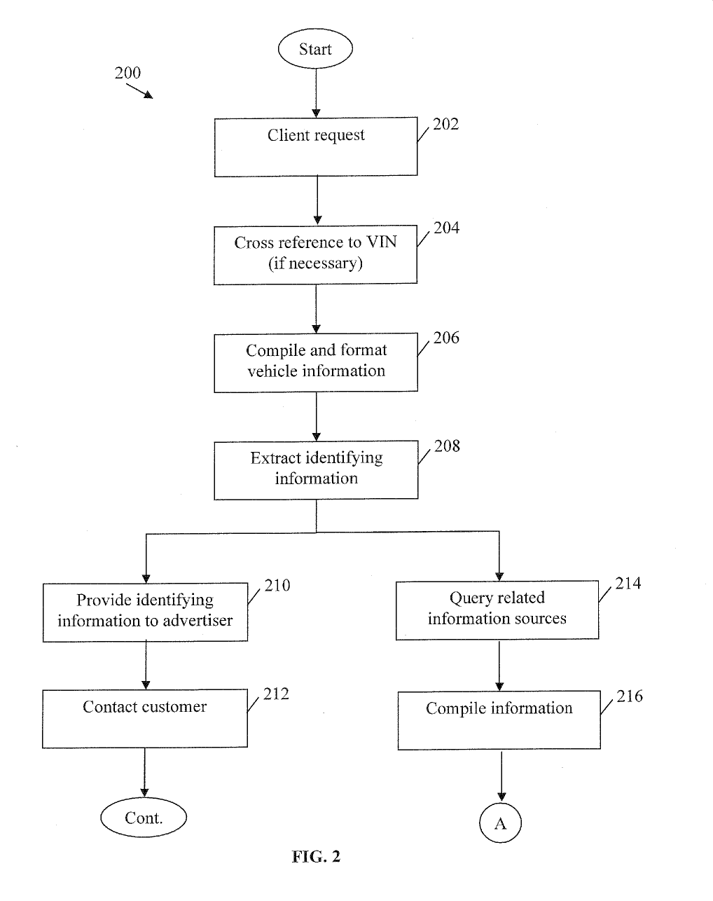

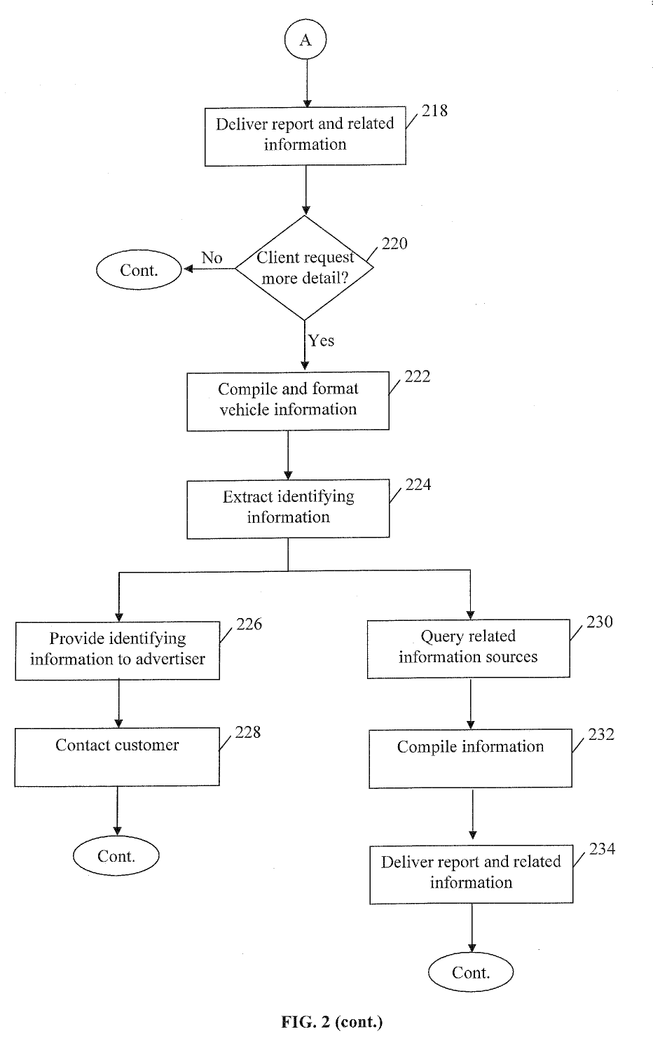

An exemplary method 200 for lead generation and utilization according to the present invention is given in FIG. 2. As shown, per step 202, a client requests information regarding a vehicle. In one embodiment, the request comprises sending an SMS text message to the IIC server 108 via the SMS server 106. This embodiment is desirable, for example, when the user is physically located at the dealership or seller's premises. Alternatively, the request for information may comprise sending an email or other Internet-based message (such as e.g., an instant message) to the IIC server 108 via a web server 104. This and other embodiments will be discussed in greater detail below; the following being described specifically with respect to. SMS text messaging for simplicity and ease of description. It is appreciated that the invention is in no way so limited, however.

The client request comprises an SMS text (or other) message identifying the vehicle for which information is sought. For example, the message may include the VIN of the subject vehicle, a shortened VIN (e.g., the last 6-8 digits), or other substantially or totally identifier. The SMS message may, in one embodiment, comprise a photographic or voice recording of the vehicle VIN. If an identifier other than the full VIN of the subject vehicle is used (such as make, model and year, and/or a photographic or voice VIN entered), per step 204, the entry may be cross-referenced to an alpha-numeric text, full VIN (thereby unequivocally identifying the particular vehicle).

The IIC server 108 then includes the VIN in a request for information, which is sent to a plurality of information sources 111. The information sources 111, in accordance with the request, send information regarding the subject vehicle to the IIC server 108. Then, per step 206, the IIC server 108 compiles and formats the vehicle information into a form that is suitable for transmission. For example, the IIC server 108 (or an application running thereon, such as the information collection and report generation application 128) may format the reported information into one or more SMS text messages, email messages, voice messages, etc. As noted previously, in one embodiment, the formatting comprises summarizing and/or presenting only portions of the data received so as to generate a message which is most germane or suitable (i.e., simple or small enough) for transmission to a client via text or other messaging in a timely and reliable manner. This approach advantageously removes the aforementioned latency associated with prior art approaches.

As the request is sent to the information sources 111 and/or after information has been received therefrom, the IIC server 108 extracts identifying information (step 208). The identifying information may comprise information identifying the requesting client device 102 (such as phone number, email address, etc.), identifying the user of the device 102 (such as demographic/psychographic information), and/or identifying the subject vehicle (such as by VIN, or items listed in the vehicle information reports).

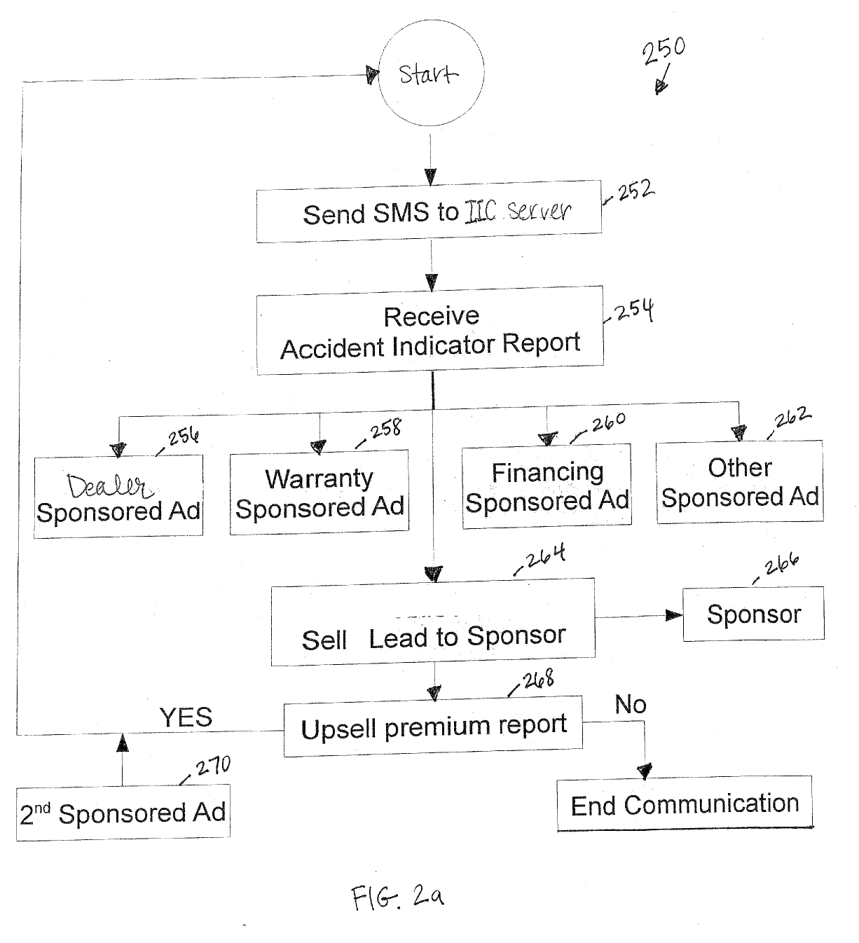

The extracted information may be provided to advertisers at step 210, which may, in turn, use the information to contact the customer (step 212). One exemplary method for utilization of the sales lead by the other advertisers 118 is illustrated in FIG. 3 (described below).

For example, when a user sends a request for information regarding e.g., a black BMW 330i, contact information for the user (e.g., a telephone number for the client device 102 associated with the user) as well as information regarding the black BMW 330i (the vehicle inquired into) is forwarded to an advertiser. In one example, the information may only be sent to the advertiser (dealer) which is selling the subject vehicle. In another example, the advertiser may be a competing dealer having a vehicle that is similar to the aforementioned black BMW 330i. In this case, the dealer may contact the user to inform him/her that a similar vehicle is available at the dealer's lot. In one embodiment, the dealer may be selected and/or forwarded information indicating the geographic location of the user at the time of the request (such as by using e.g., global positioning system (GPS) coordinates of the requesting device 102). Accordingly the advertiser (dealer) may indicate to the contacted user a distance between the vehicle which information was requested (the black BMW 330i) and the dealer's similar vehicle. Other methods of geolocation of the requesting user may be used, such as e.g., (i) association with a particular cellular base station or femtocell having a known geographic location; (ii) association with a WLAN (e.g., Wi-Fi) AP or hotspot having a known location; (ii) accessing a vehicle location device such as LoJack or OnStar; or (iv) accessing a database having vehicle location association (e.g., a database which knows that a vehicle with a particular VIN is currently located at Dealer X, the location of Dealer X being fixed and known).

The provision of information to other advertisers (at step 210) by the IIC server 108 may be based on any number of different factors. For example, the IIC server 108 may provide the information to advertisers based on the geographic proximity of the advertiser to the requesting user. Alternatively (or in conjunction), selection of an advertiser may be based on similarity of an advertiser's product to the product which the user requested information about. According to one such embodiment, only a portion of the information is provided to various advertisers, and the advertisers respond with their most similar product. The IIC server 108 then determines, based on similarity of the product to the subject vehicle and the geographic proximity (e.g., with 10 miles), which advertiser will be presented with the contact information of the customer. An operator of the IIC server 108 may charge a premium or obtain other consideration for this information (as discussed below).

In yet another embodiment, selection of an advertiser may be based at least in part on the association of the advertiser (e.g., dealer) with a service group. For example, only advertisers who have agreed to advertise with a service (such as e.g., Ebay™, AutoTrader™, Cars.com™, etc.) may be provided the extracted information. Other criterion for providing information to advertisers will be discussed elsewhere herein. It is also noted that the aforementioned basis may be used in conjunction with one another according to any number of combinations.

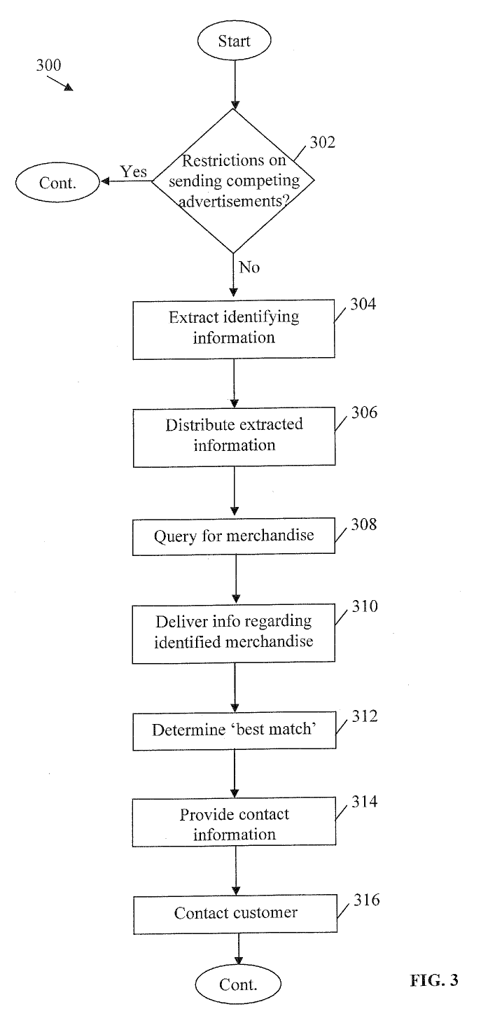

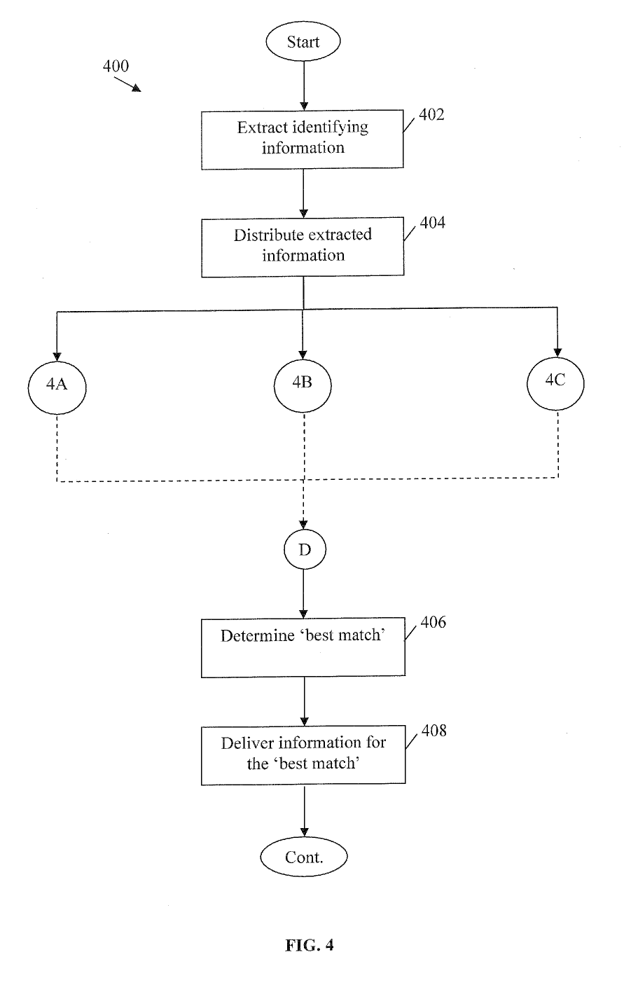

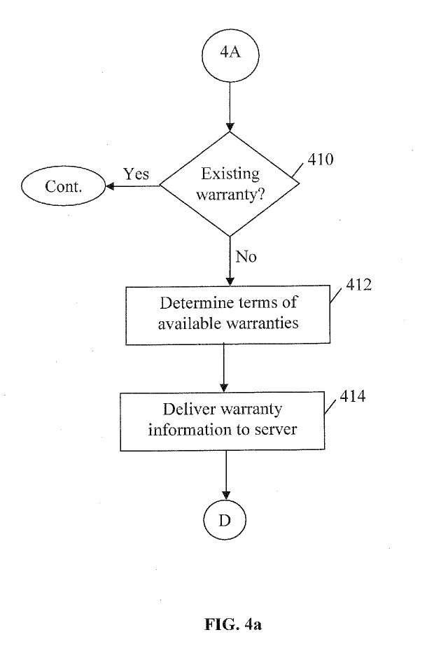

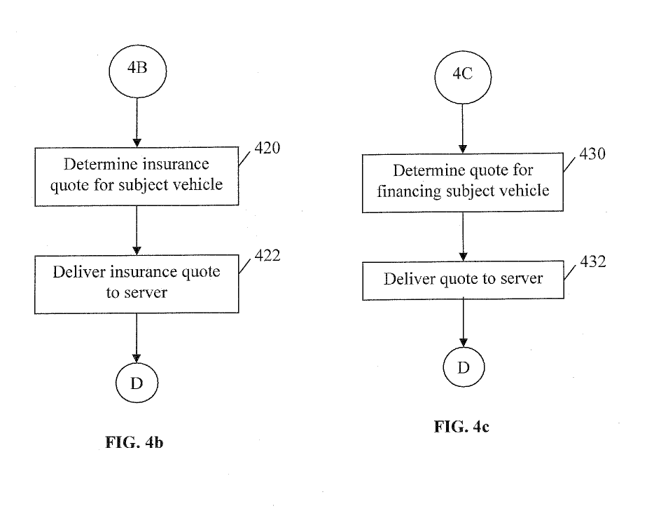

Per step 214, related products/services sources 116 may be queried using the extracted information (information relating to the requesting user, the device, or the vehicle in question). Exemplary methods for the utilization of leads by the related products/services sources 116 is given in FIGS. 4-4c (discussed below).

The query to the related products/services sources 116 results in a determination of products/services which are related to the vehicle and/or the requesting customer. In other words, the IIC server 108 may use the disclosed information to query a warranty provider, a financing provider, an insurance provider, accessories provider (e.g., car cover, anti-rust treatment, etc.) or other related product/service provider. The results are then passed back to the IIC server 108, which compiles these (step 216) and determines which are to be delivered to the user (step 218).

In one embodiment, at step 218, the formatted vehicle history report (or shortened form thereof) and the additional products/services information are presented to the user separately. Alternatively, the additional products/services may be formatted to be added to the formatted vehicle history information and presented as a single message to the user. For example, the IIC server 108 may select information from an insurance provider to accompany the (formatted) vehicle history report. In this case, the short-form information regarding the queried vehicle is provided to the client device 102, as e.g., an SMS text message. At the bottom or end of the text message, information from the insurance provider is given; a link (e.g., Internet hyperlink or URL) may also be provided to enable the user to select to receive additional information, and/or to be directed to the insurance provider should he or she be interested in obtaining insurance from the advertised company. The foregoing may be equally applicable to providing information regarding warranties, financing, etc. Information from multiple services or providers may be included as well (space permitting).

Per step 220, the client is asked whether he/she would like to receive additional information and/or a more detailed report regarding the vehicle in question. If the customer agrees to receive additional information, the IIC server 108 proceeds to query the information sources 111 for additional or more detailed information regarding the subject vehicle. In an alternative embodiment, at the first query to the information sources 111 (see step 206 above), a full report is received having as much detail as is obtainable, the IIC 108 appends the received information to generate the first report, and stores the remaining details for subsequent use, such as when the client requests additional detail (step 220).

Irrespective of where the information is obtained from, at step 222, the IIC server 108 compiles the information, and formats it into a form which is suitable for transmission to or use by the requesting device. The detailed report may be sent to the user at a different device 102. For example, the original formatted (e.g., shortened) report may be delivered to the user via SMS text to a mobile device (such as a wireless phone, personal digital assistant (PDA)), whereas the detailed report may be delivered via the Internet to a different client device (such as a personal or laptop computer), such as by email, regular post, or other message option.

Identifying information is then extracted from the user request and/or the compiled information at step 224. As noted above, the extracted information may comprise without limitation contact information for the requesting device 102 (such as a phone number, email address, etc.), information regarding the user (such as demographic/psychographic information), and/or information identifying or relating to the subject vehicle (such as VIN number, vehicle history items, etc.).

At step 226, the extracted information is provided to advertisers, who may utilize the information to contact the customer 228. In other words, when a customer requests more detailed information regarding the black BMW 330i of the above example, contact information for the customer is sent a to a second advertiser (the second advertiser may in one embodiment be the same as the first advertiser). Information regarding the black BMW 330i (the vehicle inquired into) is also forwarded to the second advertiser. As above, the second advertiser may be yet another dealer in competition with the dealer of the subject vehicle, having a vehicle that is similar to the aforementioned black BMW 330i. In this case, the second dealer may contact the user to inform him/her that a similar vehicle is available at the second dealer's lot. Using GPS (or other methods noted above), the second dealer may be made aware of the physical distance between the subject vehicle and the second dealer's location. As noted above (step 210) in one embodiment, certain rules are implemented at the IIC server 108 prior to the distribution of at least the contact information for the customer.

The extracted information may also be provided to the related products/services sources 116 as a request for information (step 230). The related products/services sources 116 may include other products/services which are offered to the customer given his/her inquiry with respect to the subject vehicle. For example, warranty providers, insurance providers, financing services providers may be queried with the aforementioned information to determine whether any of these providers is interested in offering products/services to the customer. In response to the query, the information is compiled (step 232) and delivered to the customer (step 234). As noted above, the information may be appended to the detailed report requested by the device 102, or alternatively, may be provided in a separate message of the same type (SMS text, email, voice, etc.) or different type than the detailed report.

It is further appreciated that the vehicle history reports (and formatted reports) may be stored at e.g., the IIC server 108 for future use. Accordingly, when a client device 102 requests information regarding a particular vehicle, the IIC server 108 in one embodiment first determines whether information for the vehicle has already been saved, and, if so, reports the saved information rather than querying the information sources 111 again. The vehicle information may be stored by VIN number, requesting client (so as to generate statistics regarding an individual user's preferences for future use and/or use in providing information to advertisers), requesting phone number, and/or other identifier.

In one embodiment, the methods and apparatus disclosed in co-owned, co-pending U.S. patent applicant Ser. No. 12/500, 513, filed on Jul. 9, 2009 and entitled “APPARATUS AND METHODS FOR EFFICIENT DELIVERY OF AUCTION ITEM INFORMATION”, which is incorporated herein by reference in its entirety are utilized for sending client requests and generating vehicle information reports, although other approaches can be used consistent with the present invention with equal success.

Referring now to FIG. 2a, another variant for generating and utilizing sales leads is given. As shown, per step 252 of the method, the customer sends an SMS message to the IIC server 108. The customer, in response to the request receives an accident indicator report (step 254). The accident indicator report is a shortened version of the information received from the information sources 111 (discussed above), having only information relating to whether the subject vehicle was involved in any accidents and the extent of the damage, etc. Per steps 256, 258, 260, and 262, the customer also receives one or more advertisements for e.g., a dealer (the seller of the subject vehicle or a competitor), warranties, financing, etc. The advertisements may be inserted into the accident indictor report, or alternatively may be delivered separately as previously described.

Next, per step 264, the lead is sold to a sponsor. In other words, contact information and/or other information regarding the subject vehicle is provided to an outside sponsor (step 266). The outside sponsor may be a second dealer or other product/service provider. The “sale” may be pursuant to a pre-existing contract or agreement, may be according to an ongoing auction (e.g., where dealers or other interested advertisers bid on the lead), or via any other mechanism which the parties deem useful.

It is also noted that in certain embodiments, it may be useful for the purposes of the foregoing lead sale or auction to have the derivative or extracted information available. For instance, an Aston Martin dealer may have little interest in a lead associated with a BMW VIN, since the user may not want or be able to afford an Aston Martin. Hence, portions of the VIN are used in one embodiment to determine the type, model and year of the vehicle, which accompanies the “lead” for purposes of sale, auction, or other processing.

Per step 268, the customer is presented an option to receive a premium report. The premium report may comprise any additional information received from the information sources 111 not presented in the accident indictor report. If the customer chooses to receive the upgraded or premium report, per step 270 a second sponsored advertisement may be inserted (such as by selling the lead to a sponsor as discussed above) and the method 250 begins again. If the customer does not wish to receive the premium report, communication is ended.

### Advertisers—

As discussed above, sales leads (e.g., customer contact information, user demographic/psychographic information and/or information regarding a vehicle and its history) may be provided to one or more advertisers (see e.g., FIG. 2, steps 210 and 226). FIG. 3 illustrates one method 300 for providing sales leads to advertisers according to the present invention.

As illustrated, per step 302 the IIC server 108 determines whether there are restrictions on providing competing advertisements. In other words, the lead generation application 126 of the IIC server 108 determines whether the seller for the vehicle in question is among those sellers for whom a competition is disallowed. In order to make this determination, the IIC server 108 in one variant accesses a list of VIN numbers for the vehicles associated with dealerships which have attained a non-competition status. The list may be stored at a database associated with the IIC server 108 or other entity in communication therewith. As discussed elsewhere herein, the non-competition status may be given to a dealer upon agreement to list their vehicles solely with a particular service (e.g., Ebay, AutoTrader, etc.). The vehicles of that dealer are then loaded to the database which is linked to the service provider and updated as the dealer's inventory is updated. Assume for example, that a particular VIN number, collected in the request, is determined to be associated with a vehicle for a dealer that is exclusively listed with Ebay; per step 302, no other vehicles may be advertised to the customer. If such a restriction is found, the method is ended (or restarted for another entity).

In another embodiment, the restriction may only apply to the provision of advertisement from the same service provider. In the example given above, other Ebay listed vehicles may be prevented from being advertised to the customer; however, advertisements from other dealers not using the given provider may still be permitted. In this case, the restriction is not as strict as the previously discussed restriction and at step 302 of the method the determination will be made to continue to step 304.

If a restriction is not found, and/or if the restriction is not strict so as to prevent all advertisers from providing advertisements, the method continues to step 304, wherein information is extracted from the original request received at the IIC server 108 from the client (see e.g., FIG. 2, step 202). The extracted information in this embodiment includes e.g., information regarding the various features of the identified vehicle. Thus, when the customer requests information based on a VIN, at least a portion of the information returned from the information sources (see e.g., FIG. 2, step 206) is extracted at step 304. The information may include such features as vehicle year, make and model, as well as number of doors, colors, mileage, estimated value, etc.

Per step 306, the extracted information is then distributed to one or more other vehicle advertisers 118. It is noted that at this step, a filter may be applied to ensure that the information is only distributed to eligible advertisers. That is, according to the embodiments above, in some instances (where the restrictions are not strict) advertisers may still advertise to a customer despite that the subject vehicle is associated with a dealer that is a subscriber to a particular service provider (e.g., Ebay).

It is also noted that in another variant, the IIC server may simply pass the VIN of the user's request to the advertiser(s) 118 directly, and allow them to determine the make, model, year, etc. if interested, such as via a VIN database to which they have access.

The advertisers use the provided information to identify merchandise which may suit the customer's needs. For example, if the information indicates that the subject vehicle is a silver, 2006 Toyota Camry 4-door, the dealer may query its database of merchandise, and discover a black, 2006 Toyota Camry 4-door. Each advertiser may have its own criteria for determining which inventory items will be selected (or which leads will be obtained in the first place, as noted above). Information regarding each of these is then delivered to the IIC server 108 from the various advertisers at step 310. It is appreciated that in one embodiment, the advertisers provide only their closest match (i.e., the vehicle which is most similar to the subject vehicle); alternatively, the advertisers may provide information regarding more than one vehicle, some of which may not be a “match” per se.

At step 312, information regarding vehicles from all of the advertisers is examined in order to determine a “best match”. In one embodiment, the determination of the “best match” may be based on the closeness of the vehicles proposed by each advertiser to the subject vehicle (i.e., the vehicle which the customer was originally interested in receiving information about). The determination of the “best match” may alternatively (or additionally) be based on geographic closeness to the determined position of the customer (using GPS). Other bases or criteria for selecting one or more of the advertised vehicles may be utilized in conjunction with the present invention as well, the foregoing being merely illustrative. As will be discussed below, it may be advantageous to employ one or more business rules to the selection of an advertiser. For instance, those advertisers who pay higher premiums may be favored for selection over other tiered advertisers.

The selected advertiser(s) (the determined “best match(es)”) is/are provided contact information for the requesting device 102 (step 314). The contact information may include a telephone number, email address, or other information for contacting the customer. It may also include user- or service-specified restrictions or rules (don't call outside normal working hours, don't call after one hour, only call on weekends, contact only via email, etc.). Per step 316, the customer is contacted by the selected advertiser in accordance with any rules. For example, if a telephone number is provided at step 314, then the customer may be contacted by voice, text or multimedia message; if an email is provided, the customer may be contacted via email, etc.

### Additional Services—

As discussed above, sales leads (e.g., user demographic/psychographic information and/or information regarding a vehicle and its history) may also be provided to one or more additional service providers (see e.g., FIG. 2, steps 214 and 230). FIG. 4 illustrates an exemplary method 400 for providing sales leads to additional service providers according to the present invention.

Per step 402 of the method, information is extracted from the original request received at the IIC server 108 from the client (see e.g., FIG. 2, step 202). The extracted information in this embodiment includes e.g., information regarding the various features of the identified vehicle. In one variant, information regarding the user may also be derived and provided to the additional service providers. For example, the IIC server 108 (or other entity in communication therewith) may use the telephone number of the requesting user in a reverse look-up to determine a name and address (or other information regarding the customer). This information is then provided to outside sources (such as Experian, Trans Union, and other credit or credit card agencies) which use the information to generate an estimated or “soft” FICO score for the customer (or other identifier of credit worthiness). The soft FICO score may be added to the extracted information.

Per step 404, the extracted information is then passed to several related products/services sources 116 (reference numerals 4A, 4B, and 4C of FIGS. 4, 4a, 4b, and 4c). It is noted that at this step, a filter may be applied to ensure that the information is only distributed to certain related products/services sources 116 (discussed below). In the embodiment of FIG. 4, the related products/services sources 116 include: (a) one or more warranty providers, (b) one or more insurance providers, and (c) one or more financing providers. It is appreciated, however, that alternative or additional product/service providers may be utilized as well; e.g., vehicle accessory providers, vehicle detailing or servicing providers, auto or motorcycle clubs, vehicle service manual providers, vehicle transport providers (e.g., where the user is purchasing a vehicle out of their area and wants it shipped), vehicle rental providers, etc.

FIG. 4a illustrates the lead generation method relating specifically to the one or more warranty providers, as these are provided with the extracted information (step 404 of FIG. 4). As shown, per step 410, the warranty provider determines whether a warranty already exists for the subject vehicle. In one embodiment, the warranty provider makes this determination by cross-checking the vehicle VIN against a database of other known warranty providers, or by information extracted or forwarded by the IIC server. Alternatively, the warranty provider may make the determination by comparing the vehicle make, year, and/or mileage to a known listing of warranties for that vehicle make. Suppose for example, the vehicle in question is a 2005 BMW having 65,000 miles. The warranty provider receives this information, and compares it to what is known about the basic warranty offered when the vehicle was first sold. For example, a basic warranty on a new BMW vehicle is 4 years/50,000 miles. Thus, when the warranty provider compares the year of the car in question (2005) to the present year (2010) and/or the current mileage to the mileage limit on the warranty, the warranty provider will determine, in this example, that a warranty likely does not currently exist for the vehicle. It is appreciated that the foregoing determination may not be a so-called “hard line” determination, but rather, if the existing warranty is set to expire shortly, the vehicle may be treated herein as not having an existing warranty. Moreover, a different advertising or sales approach may be used if the vehicle has (i) an extant warranty not set to expire soon; (ii) an extant warranty set to expire soon, (iii) no warranty; or (iv) a warranty which is not all inclusive or “bumper to bumper”, thereby ostensibly requiring complementary coverage.

If a warranty does not currently exist (or other criteria are met as noted above), per step 412 of the method, the terms of available warranties are determined. The warranty terms may be uniform for an individual warranty provider, or may vary based on one or more criteria such as year, make, model, mileage of the vehicle, etc. They may also be requester-based; e.g., those with higher income, credit score, etc may be given a more favorable package or terms. The terms of available warranties may be specific to the individual warranty providers and thus are not discussed in detail herein. The available warranty options are then provided to the IIC server 108 (step 414) for further evaluation (reference numeral D of FIGS. 4 and 4a)

FIG. 4b illustrates the lead generation method relating specifically to the one or more insurance providers as these are provided with the extracted information (step 404 of. FIG. 4). As shown, per step 420, the insurance provider determines an insurance quote for the subject vehicle given the extracted information. For example, the insurance provider may use the vehicle description (color, make, model, year, etc.), as well as the credit worthiness of the customer (discussed above) to generate an insurance quote. The quote is then delivered to the IIC server 108 for further evaluation (reference numeral D of FIGS. 4 and 4b).

FIG. 4c illustrates the lead generation method relating specifically to the one or more financing providers as these are provided with the extracted information (step 404 of FIG. 4). As shown, per step 430, the financing provider determines a quote for providing financing for the subject vehicle given the extracted information. For example, the financing provider may use the vehicle estimated value, items from the vehicle history report (relating to the current condition of the vehicle), as well as the credit worthiness of the customer (discussed above) to generate a financing quote. The quote is then delivered to the IIC server 108 for further evaluation (reference numeral D of FIGS. 4 and 4b).

Referring back to FIG. 4, the information provided from each of the one or more warranty, insurance, and/or financing providers (at reference numeral D), is optionally evaluated to determine at step 406 one or more “best matches”. In one embodiment, a best match is determined based on the substance of the quote. For example, the best match may be the provider offering the best deal to the customer. Alternatively, the best match decision may be made according to one or more business rules for generating profit to the operator of the IIC server 108. For example, certain ones of the related products/services provider 116 may pay higher premiums to have their products advertised more often (e.g., selected as the “best match”). Alternatively, quotes from multiple service providers can be selected, and/or ranked. In the case where only one quote for a given service is provided, there is no evaluation performed (other than perhaps application of a user- or service- specified rule such as “Don't use Company X for insurance” or the like).

Next, per step 408, information provided from the best match is delivered to the customer. The provided information may be formatted (as discussed above) into a format suitable for transmission to the customer. For example, if the original report of information regarding the subject vehicle is delivered via SMS text, the best match related products/services information may also be formatted to SMS text. The related products/services information may be provided in a separate message or may be appended to the bottom of the original report message during an additional formatting step (not shown). The related product/services information may comprise a link which enables the customer to select to receive additional information and/or to be directed to the related product/service provider (e.g., the warranty service, insurance service, and/or financing service) should he or she be interested in obtaining insurance from the advertised provider.

### Web-Based Embodiment—

As noted previously, the methods and apparatus of the invention may also be utilized to provide lead generation and utilization in a web-based environment. According to this embodiment, a customer reviews available vehicles on a website, such as a dealer's website or provider website (such as e.g., Ebay, AutoTrader, etc.). A user interested in obtaining information about a particular vehicle may indicate interest by, for example, clicking on the vehicle or a button advertising the availability of a vehicle history report (including a shortened report). In response to this indication, information is collected from the customer. For example, the customer may be required to fill out an online form including contact information, demographic information, geographic location, and billing information (in the event the customer is to be charged a premium for receiving the formation).

The aforementioned information is then provided to the web server 104. It is appreciated that the web server 104 is preloaded with the VIN numbers for each of the vehicles displayed on its website. Hence, this information need not be entered by the customer. The customer information and VIN (as well as any other information maintained at the web server 104 regarding the subject vehicle) is transmitted to the IIC server 108. The IIC server 108 uses this information, as in the methods described above (see e.g., FIG. 2) in a request to the vehicle information sources 111, related products/services sources 116 and other vehicle advertisers 118 (where appropriate), to compile information therefrom.

The information received is formatted and, as discussed above, any related products/services are identified and added to the formatted information (if necessary). The IIC server 108 may then return to the client device 105 (e.g., via the web server 104) a formatted vehicle history report (including a shortened form thereof) and advertisements for related products/services (such as financing options, insurance, and/or warranties). These may be returned to the customer in the form of an email message, an SMS text message (to a separate device 102 via the SMS server 106), pop-up window, and/or an instant message.

As described in detail above, the various types of information are needed by the various information sources 111, advertisers 118 and related products/services providers 116 is extracted or provided to the IIC server 108 and subsequently provided to these entities.

### Error Detection/Correction—

The various embodiments of the invention described herein may also be configured with an ambiguity resolution system or algorithm. For example, suppose a user enters a VIN or portion thereof which is one digit off from the actual number, or has two numbers transposed. This could cause the system to return an erroneous report (or none at all), thereby wasting the time and money of the customer. Accordingly, several mechanisms can be used to mitigate this circumstance. In one variant, a client-entered number (whether via textual or graphical UI, speech, scanner, or otherwise) will be evaluated by the user prior to sending a request to the IIC server 108. For example, the entered number may be displayed with an option for the customer to agree that the entered VIN is correct, or disagree and re-start. If the VIN were entered via speech, camera, scanner, etc., the customer may evaluate the entered number via a display and/or oral representation of entered VIN.

In more sophisticated embodiments, the error checking functions comprise the user entering one or more additional pieces of information about the vehicle so that the entered VIN can be cross-referenced. For instance, along with the VIN, the user might also enter or say “Aston Martin” (referring to the mfgr.) and “black” (referring to the vehicle's color). The back-end server can then also match these elements (which may be coded by numbers, letters, etc. which are derived from the user's “plain language” input) to those stored with the VIN for the vehicle, in effect cross-checking the VIN and additional data to be sure that all match up. If, for example, the VIN entered by the user is one digit off, it may return a different color vehicle, which would indicate an error in the VIN somewhere. In this way, the user will not be inadvertently “spoofed” by receiving a message from the server 108 with information that ostensibly appears to be relevant, but in fact actually relates to a totally different vehicle.

In another variant, the entered VIN may return pre-report information (information describing the vehicle sent to the customer prior to the formatted report). The pre-report information must be verified by the user in order to trigger the server 108 to continue to compile information regarding the subject vehicle. Suppose for example the customer is interested in obtaining information about a blue Toyota 2-door truck. The customer enters the VIN, triggering the IIC server 108 to obtain pre-report information. In this example, we will suppose the customer's VIN entry was not correct and the pre-report information indicates the subject vehicle as a black Toyota 4-door car. The pre-report information, when sent to the customer is not verified, which causes the IIC server 108 to halt generation of a report on the incorrect vehicle and prompts the user to re-enter the VIN of the subject vehicle.

In yet another variant, the user-entered VIN (or portion of a VIN) is analyzed by the IIC server or other entity for valid ranges of numbers. For instance, certain digits within a VIN may only have certain ranges of letters or numbers (based on the values in other digits). For instance, the combination “SAJDA4” may be viable as the first 6 digits of a VIN for a Jaguar XKR convertible, whereas “SAJDB4” may not be viable for that vehicle (or any other).

Other methods for error detection/correction may be utilized in conjunction with the present invention as well.

### Item Information Collection Using Short Form VIN—

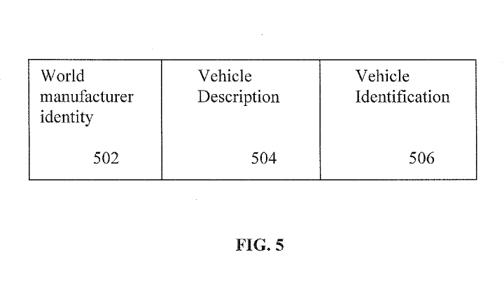

A world-wide standard established by the International Organization for Standardization (ISO) for VIN systems has been implemented in many countries. As illustrated in FIG. 5, according to the standard, the VIN comprises three sections; the first section describes the world manufacturer identity 502, the second describes the vehicle 504, and the third identifies the vehicle 506. The last 6-8 digits of the vehicle identification section 506 generally are standardized to indicate a serial number and assembly line where a particular vehicle was manufactured, the number the vehicle was off the line, and the plant which manufactured the vehicle. Thus, the final few digits of a vehicle's VIN in many instances comprise a series of numbers which are completely unique to that particular vehicle.

Accordingly, in another embodiment of the present invention, rather than using a full seventeen (17) digit VIN, a shortened form of the VIN (the final 6-8 digits) may be provided to the IIC server 108 to receive information about the vehicle. In other words, a user, in one embodiment, may simply transmit the last 6-8 digits of a VIN to the server 108. The user will then be returned the formatted report corresponding to the vehicle in question and associated/related advertisements, etc.

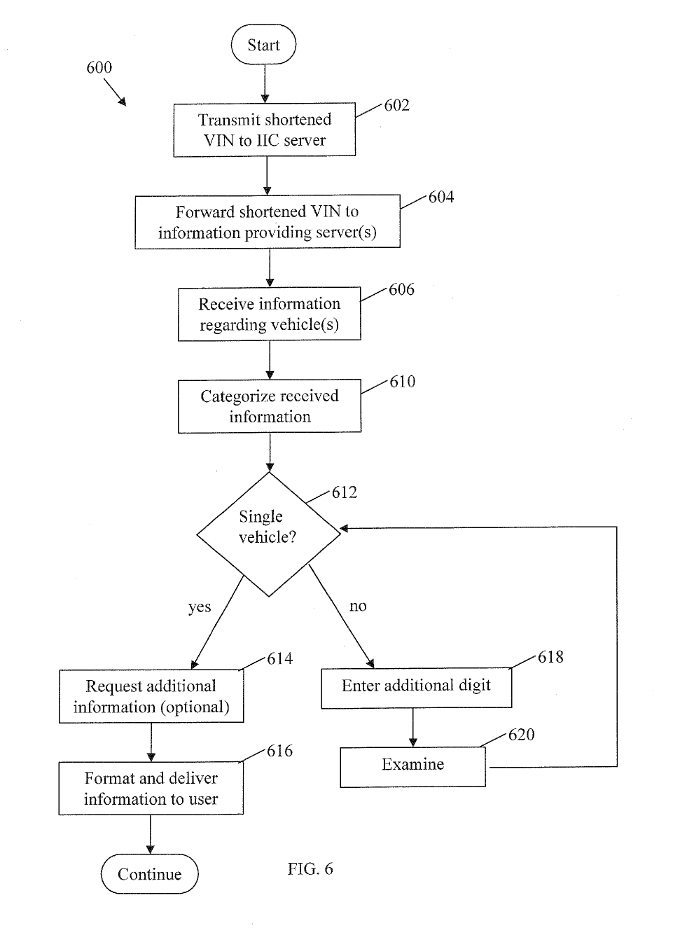

As noted previously, the final 6-8 digits of a VIN are often unique to a particular vehicle. However, in certain cases the final 6-8 digits of a VIN will produce ambiguous results; i.e., may not be unique to a single vehicle, but instead may be identical for two or more vehicles. In order to determine whether the submission of the final 6-8 digits of a VIN to the IIC server 108 will produce ambiguous results, a computer program may be run on the IIC server 108 and perform the methods disclosed herein with respect to FIG. 6.

Per step 602 of the method 600, the computer program prompts the user to enter only the final 6-8 digits; the shortened VIN is then transmitted to the IIC server 108. The IIC server 108 then, per step 604, sends the shortened VIN to one or all of the vehicle information sources 111. At step 606, the IIC server 108 receives from the vehicle information source(s) 111 information regarding the one or more vehicles matching the shortened VIN. For example, if the IIC server 108 merely sends the information to e.g., the vehicle history information source 112, information regarding every automobile having sharing the shortened VIN will be returned.

Per step 608, the computer program running on the IIC server 108 examines the received information from the information source(s) 111 and organizes the results into one or more categorizes (step 610) based on the complete VIN of the subject vehicle. Per step 612, it is determined whether the information collected regards a single vehicle. If results regard a single vehicle (i.e., a single complete VIN), then the organization will produce a single category at step 610. If the information regards a single vehicle only, the computer program may then proceed at step 614 to request additional information from any remaining vehicle information sources 111 using the VIN (if necessary) and the information is formatted and delivered to the customer as disclosed above with respect to the method of FIG. 2 (step 616); information regarding related products/services may also be provided. It is further appreciated that, as discussed above, information may be extracted for provision to other vehicle advertisers 118 as well.

At step 612, if it is determined that two or more vehicles share the shortened VIN, the computer program may be configured to prompt the user for entry of an additional digit (step 618). In other words, the user may be prompted to enter the digit of the VIN which immediately precedes the entered 6-8 digits. At step 620, the computer program utilizes the additional digit to examine the various vehicles sharing the shortened VIN. If the provided digit enables the computer program to narrow the pool of vehicles to just one vehicle (step 612), then the method proceeds to step 614. If it still cannot be determined which vehicle a user is requesting information about, the program may continue to prompt the user for more digits (step 618).

### Verbal Reporting—

It is further appreciated that the aforementioned systems and methods may be implemented using verbal requests and/or reports. According to this embodiment, a customer connects to a telephone access system, such as by dialing a telephone extension (e.g., a toll-free 800 or 866 number). The telephone access system may comprise an automated system, which prompts the customer to speak, or dial a VIN (or shortened VIN). The VIN is then optionally confirmed, such as by a mechanism for verbally repeating the VIN back to the user so that the user may confirm (such as by pressing a key to indicate correctness). If the VIN is determined to be incorrect, the customer may be given an option to indicate it is incorrect and re-enter it (either by speaking or dialing); thereby resulting in reduced erroneous reporting.

The entered VIN may then be used to obtain information regarding the item as discussed above. The customer can select from among one or more options for the presentation of the item information. For example, the user may select to have the information presented verbally (such as via a computer automated speech synthesis system), or presented in email, text/SMS message or other message form. Compiled and formatted information (including information regarding related products/services) is then presented to the user via the selected mode. Information extracted from the user may also be used (ad discussed above) for advertising from other vehicle advertisers.

Moreover, “verbal” request can be used as previously noted in conjunction with SMS or web-based services as well; e.g., using a speech recognition algorithm running on the user's client device 102 or a dealer's computer, which then formats the spoken data into the appropriate electronic communication.

### Business Methods and Considerations—

Various exemplary business-related aspects of present invention are now described in detail.

In one embodiment, access to vehicle history reports (including shortened versions thereof) are provided upon payment of a service fee; the amount of the fee may be made relative to the amount of information being reported. For example, access to a full report (such as one containing all information about a vehicle from every information server) may be offered at a higher premium than access to a partial report (such as one comprising short messages generally summarizing information from one or all of the information servers). In one instance, a customer may be charged 99¢ for a shortened report (requested at step 202 of the method of FIGS. 2) and $6.99 for a HI report (the additional detail requested at step 220 of the method of FIG. 2). It is noted that these prices are merely exemplary and other prices may be utilized in accordance with the present invention. One salient advantage for charging customers for access to the shortened report is that it is via this method that the customer may be qualified as a highly interested/highly motivated buyer. Accordingly, the leads generated from the customer's inquiry are qualified leads and may command a higher premium for their sale. Thus, the operator of the IIC server 108 may charge higher premiums for the provision of information regarding a customer and/or the subject vehicle to the related products/services sources 116 and/or to the other vehicle advertisers 118.

In another example, a user may be given an option to receive both a full report and a partial report simultaneously (as a package) upon the payment of a single premium, often lower than the combined price of the individual reports. According to this embodiment, the full report is sent to an email inbox and the partial report is sent via SMS text message, voice message, or other shortened form to the client device 102; however, other distribution mechanisms may be employed with equal success.

It is also appreciated that the cost for the aforementioned services may be offered on per item inquired into (such as per automobile) basis. Alternatively, a user may purchase a subscription for access to the services such as on a weekly, monthly, etc. plan basis.

In another embodiment, the information provided to the advertisers may be reduced in value such as by omitting certain information and/or selling the lead to multiple parties in a tiered manner. For example, an advertiser may pay a reduced premium for leads including only information regarding the customer (e.g., contact information, demographics, etc.), and a higher premium for leads including both the customer information and information regarding the subject vehicle (e.g., vehicle year, make, model, etc.).

In a further embodiment, the advertisers (including other vehicle advertisers 118 and related product/services providers 116) may pay premiums to the operator of the IIC server 108 on a per-click basis. For example, the advertisers may be provided with an opportunity to have information regarding their advertised product/service (such as e.g., other comparable vehicle, warranty, insurance, financing services, etc.) presented to the customer without paying a premium for this service. The advertiser is only charged if the customer makes an indication that he/she is interested in the presented information. A customer indication may include, inter alia, the customer clicking on an embedded link, requesting additional information regarding the advertised product/service, and/or actual purchase thereof.

The present invention also may be configured to permit latent or delayed contacts; e.g., contacting a customer or purchaser of a vehicle. For instance, a vehicle warranty service may obtain a lead for John Jones, and present him with an advertisement (e.g., as part of the aforementioned text message approach), yet John Jones is not interested in the warranty at that time (but none-the-less purchases the vehicle). The warranty provider, knowing that the VIN of the vehicle purchased by John Jones corresponds to an Aston Martin DBS, also knows when the warranty will expire. Hence, the advertiser may “sit on” the lead until the date of warranty expiration approaches, and then contact John Jones again to see if he is now interested in further warranty coverage.

Moreover, such leads can be sold (via e.g., a secondary market, online portal, or any other mechanism), since this knowledge has distinct value. Under one business paradigm, the value of the lead can be tied to one or more factors, such as (i) the credit-worthiness of the customer associated with the lead; (ii) the type/price of vehicle; (iii) the ostensible need for the warranty services (i.e., the vehicle was a Toyota with known and recurring defects, and hence the chances that the user might need service under the warranty is higher; (iv) the temporal proximity to the triggering event (e.g., how close in time it is to the warranty expiring), and so forth.

In another aspect of the invention, the timeliness or lack of latency inherent in various embodiments of the invention yet further enhanced by permitting the advertiser to be contacted via non-latent channels. For instance, even if the lead is generated instantaneously while the prospective customer is at the dealer's lot, and the lead provided to an advertiser, the lead may sit in the advertiser's queue or inbox (depending on how delivered) for an extended period of time, even days for example if over a weekend, thereby significantly defeating the utility to the customer. Hence, embodiments of the present invention contemplate low-latency communications with the advertiser, such as via IM, text message, pager, or cellular telephone call. For instance, and advertiser might configure their 3G or 4G smartphone to utilize a distinctive ring or vibration pattern or display graphic for “hot leads”, thereby allowing the advertiser to respond as rapidly as possible. Myriad other approaches to getting the attention of the advertiser in a rapid fashion will be recognized by those of ordinary skill given the present disclosure.

In another variant of the invention, leads are based on vehicle value. For example, for a person shopping for a new (unused) vehicle, there will be no vehicle history per se. However, what may be useful to that individual is the dealer's cost or other similar valuation, so that for instance the purchaser can estimate how much markup a given dealer is applying. As another example, a prospective purchaser of a used car may, in addition to history, want to know the “Kelly Bluebook” or similar third party valuation estimate. This information can also be provided to any potential advertiser obtaining the lead. For instance, the aforementioned purchaser of the new vehicle might enter the VIN, and the generated lead would indicate the type of vehicle and value to the advertiser, which may be useful to them in deciding whether to contact the prospective purchaser (e.g., whether they could offer a better deal).

In another example, the person shopping for a new (unused) vehicle may be interested in the various options available on the vehicle. For instance, the purchaser may be able to enter the VIN (or other identifying information) and receive in response a listing of the availability of other similar vehicles offering different features (such as color, fabrics/leather, packages, etc.) The other vehicles may be co-located with the searched vehicle or may be located elsewhere (such as at a different dealership). Geographic constraints may be implemented in providing other available vehicles, such as using information known about the requesting user's telephone and/or the user's current location. In one variant, the user may indicate those features which he/she would like all presented vehicles to have and/or those which the user is more flexible on.

In yet another aspect, various embodiments of the invention may be configured to be useful in non-vehicle contexts, e.g., service industry, informational, etc. Moreover, the invention may be adapted to provide contextual leads based on, e.g., the type of service or information requested. For instance, in one exemplary embodiment, the invention is configured to provide real estate information. The user enters e.g., the assessor's parcel number, address, etc. of a property in which they are interested (generally analogous to the foregoing VIN), and a property title search or “history” is returned, and a lead generated (e.g., for use by a real estate agent, title company, insurer, home inspection service, appraiser, etc.). The prospective buyer can then be immediately contacted if desired (or contacted in a latent fashion, such as in the foregoing warranty expiration example) to determine their interest in the advertiser or lead consumer's product or service. Similarly, a background check paradigm is envisioned; e.g., enter the target person's SSN or name/address, etc., and all or part of a background check is performed on that person, and a lead optionally generated (e.g., for investigative services, attorneys, etc.). This latter embodiment is particularly useful in the scenario of dating or interpersonal relationships due to inter alia the need for rapid, non-latent information on a person (i.e., whether the person is who they say they are, whether they present a safety concern, are a convicted criminal, are wanted by the police, etc,). Myriad other application scenarios and industries may benefit from the present invention (including e.g., medical services, checks of law enforcement personnel (i.e., enter their badge number to determine their authenticity before letting them enter a premises, etc.), such applications being readily envisaged given the present disclosure.

### Operations/Business Rules Engine—

In another aspect of the invention, the aforementioned processor 124 running on the IIC server 108 (or one or more computer programs located thereon) includes a so-called “rules” engine. These rules may be fully integrated within various entities associated with the present invention, or may be controlled via e.g., an operator-managed device (not shown). In effect, the rules engine comprises a supervisory entity, which monitors and selectively controls the item information acquisition and delivery, as well as the lead generation and provision functions at a higher level, so as to implement desired operational or business rules. The rules engine can be considered an overlay of sorts to the information management and delivery algorithms.

For example, one rule implemented by the rules engine may comprise providing “filters” to the determination of which product and service providers (e.g., other vehicle advertisers 118 and related products/services sources 116) customer and/or subject vehicle information may be provided to. As noted above, certain dealers may have exclusivity with respect to a desired customer. In other words, if a dealer has agreed to utilize only the services of a particular advertising service (such as Ebay, AutoTrader, etc.), a customer requesting information regarding a vehicle provided by that dealer will not receive advertisements for vehicles from other dealers. In one variant, the customer may only be prohibited from receiving advertisements from other dealers also using the particular advertising service (i.e., an Ebay dealer will not have to worry about its customers being provided advertisements for other Ebay vehicles). In order to affect this prohibition on advertising, the business rules engine may communicate rules (filters) to the lead generation and utilization application 126. One rule may be indicate that the application 126 must, prior to sending customer and/or vehicle information to an advertiser determine whether there are restrictions on doing so.

A filter may also be utilized with respect to the information which is provided from the aforementioned product and service providers to the customer. As discussed above, the IIC server 108 must determine the “best match” for providing advertisements for related products/services to the client. In one embodiment, the rules engine may set forth rules indicating that the best match is to be the vehicle which is closest in year, model, make, and mileage to the subject vehicle; hence, the vehicles proposed by each advertiser will be examined according to these criteria for closeness to the subject vehicle. It is appreciated that other criterion for closeness may be utilized in addition or alternatively. In one variant, the one or more vehicles which have a threshold level of similarity to the subject vehicle are permitted to advertise. Alternatively, only the most closely matched vehicle will be allowed to be advertised. The rules for determination of the best match may alternatively (or additionally) include other factors such as geographic closeness of the advertised vehicle to the determined position of the customer.

In another embodiment, the rules engine may be configured to cause the selection of those advertisers who pay higher premiums over other tiered advertisers when determining a “best match”.

In yet another embodiment, the rules engine may promulgate rules causing the best match to be determined based on the substance of a quote or offered terms (such as an insurance or financing quote, or warranty terms). The rules may indicate that the best match be the provider offering the best deal to the customer. Alternatively, the best match decision may be guided by rules for generating the most profit to the operator of the IIC server 108. For example, certain ones of the related products/services provider 116 may pay higher premiums to have their products advertised more often (e.g., selected as the “best match”).

Many other approaches and combinations are envisaged consistent with the invention, as will be recognized by those of ordinary skill when provided this disclosure.

It should be recognized that while the foregoing discussion of the various aspects of the invention has described specific sequences of steps necessary to perform the methods of the present invention, other sequences of steps may be used depending on the particular application. Specifically, additional steps may be added, and other steps deleted as being optional. Furthermore, the order of performance of certain steps may be permuted, and/or performed in parallel with other steps. Hence, the specific methods disclosed herein are merely exemplary of the broader methods of the invention.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The described embodiments are to be considered in all respects only illustrative and not restrictive. The scope of the invention is, therefore, indicated by the appended claims rather than the foregoing description. All changes that come within the meaning and range of equivalence of the claims are to be embraced within their scope.

What is claimed is:

1. A method for generating and utilizing sales leads, said method comprising:
receiving a request for first information regarding an item for sale from a user device;
transmitting second information associated with said request to one or more advertising entities;
receiving in response to said second information, at least one advertisement;
obtaining said requested first information;
formatting said requested first information and said at least one advertisement into a format suitable for use by said user device; and
transmitting said requested first information and said at least one advertisement to said user device.

2. The method of claim 1, wherein said formatting comprising formatting into an SMS or text message format having a limited number of characters.

3. The method of claim 1, wherein said second information comprises information descriptive of said item for sale, and said at least one advertisement comprises an advertisement that is in at least one aspect contextually related to said item.

4. The method of claim 1, wherein said act of receiving said at least one advertisement comprises receiving a plurality of advertisements, and said method further comprises employing one or more business rules for determining which of said plurality of advertisements to transmit to said user device.

5. The method of claim 1, wherein said second information comprises information relating to a geographic location of said user device, and said at least one advertisement is further in at least one aspect related to said geographic location of said user device.

6. The method of claim 1, wherein said second information is transmitted to specified ones of said one or more advertising entities based on one or more business rules.

7. The method of claim 1, wherein said at least one advertisement comprises an advertisement from an entity for providing an item similar to the item about which information was requested.

8. A method for generating and utilizing sales leads, said method comprising:
receiving a request for information regarding a particular item for sale from a client device, said request being received in the form of a short message service (SMS) message;
transmitting at least a portion of information contained in said request to one or more item information sources, said item information sources being configured to provide information regarding said particular item for sale based at least in part on said at least portion of information;
extracting data contained in said request;
providing said extracted data to one or more advertising entities, said advertising entities being configured to provide advertisements for products or services related to said particular item for sale;
receiving said requested information regarding said particular item for sale; and
formatting said requested information into a format suitable for transmission to said client device.

9. The method of claim 8, wherein said format suitable for transmission to said is client device comprises an SMS message format.

10. The method of claim 8, wherein said particular item for sale comprises a particular vehicle, said at least first portion of information comprises a vehicle identification number (VIN).

11. The method of claim 10, wherein said at least second portion of information comprises descriptive information regarding said particular vehicle derived from said VIN and said one or more advertising entities are associate with one or more of:
a warranty provider;
a financing provider; and
an insurance provider.

12. The method of claim 8, further comprising:
receiving at least one advertisement, said advertisement related to said particular item for sale, and being selected based at least in part on said at least second portion of information contained in said request; and
formatting said at least one advertisement into a format suitable for transmission to said client device.

13. The method of claim 12, further comprising transmitting said requested information and said at least one advertisement to said client device as a single SMS text message.

14. The method of claim 12, further comprising transmitting said requested information to said client device in a first SMS text message, and transmitting said at least one advertisement to said client device in a second SMS text message.

15. The method of claim 12, wherein said extracted data is useful to said one or more advertising entities to directly contact a user of said client device.

16. A server apparatus, comprising:
at least one interface configured to provide communication between the server apparatus and one or more remote entities; and
at least one processor, said processor configured to run at least one computer program thereon, said computer program configured to, when executed:
receive a request for information regarding an item for sale from a user device;
query one or more information-containing entities for said information regarding said item for sale;
compile information regarding at least one of a user of said user device, said user device itself, and said item for sale for transmission to one or more advertisement-generating entities;
receive said information regarding said item for sale; and
transmit said information regarding said item for sale to said user device.

17. The server apparatus of claim 16, wherein said computer program is further configured to, when executed, format said information regarding said item for sale into said format suitable for said user device.

18. The server apparatus of claim 16, wherein said compiled information comprises user-specific data derived from said information requests.

19. The server apparatus of claim 16, wherein said computer program is further configured to, when executed, receive at least one advertisement from said one or more advertisement-generating entities, and provide said at least one advertisement to said user device.

20. The server apparatus of claim 16, wherein said computer program is further configured to, when executed, receive a comprehensive second set of information regarding said item for sale, and transmit said comprehensive second set of information to a second user device, said second user device associated with a user of said first user device.

21. The server apparatus of claim 16, wherein said transmission of said information to said one or more advertisement-generating entities is based at least in part on one or more business rules and payment of consideration for said information by said one or more advertisement-generating entities.

22. A client device adapted for issuing requests relating to goods or services comprising:
at least one interface for communication between said client device and other remote entities; and
a processor, said processor comprising at least one client application thereon, said client application which, when executed:
enables a user of said client device to create a message requesting information regarding an item for sale, said message comprising at least information descriptive of said item;
transmits said message to a remote server entity;
receives said information regarding said item and at least one advertisement related to said item; and
enables said user to request additional information regarding said item or said advertisement.

23. The client device of claim 22, wherein said device comprises a mobile device enabled with SMS or text messaging capability.

24. The client device of claim 22, wherein said receipt of said information regarding said item and said at least one advertisement related to said item are temporally proximate one another.

25. The client device of claim 22, wherein said at least one advertisement related to said item comprises an advertisement for an item similar to said item in one or more respects.
